(19) United States
(12) Patent Application Publication
(10) Pub. No.: US 2025/0251299 A1
(43) Pub. Date: Aug. 7, 2025

(54) LEAKAGE DETECTOR

(71) Applicant: HONDA MOTOR CO., LTD., Tokyo (JP)

(72) Inventors: Tatsuru SHISHIDO, Saitama (JP); Yoshihiro YAMASHITA, Saitama (JP); Ryo TAKANO, Saitama (JP); Takahiro TANAKA, Saitama (JP)

(21) Appl. No.: 19/045,570

(22) Filed: Feb. 5, 2025

(30) Foreign Application Priority Data
Feb. 7, 2024 (JP) 2024-017396

(51) Int. Cl. G01M 3/22; H01M 8/04664

(52) U.S. Cl. CPC G01M 3/229; H01M 8/04679

(57) ABSTRACT

To provide a leakage detector that can improve energy efficiency by making it possible to suppress an increase in the number of man hours required in a process of producing a fuel cell stack. A leakage detector 1, 61 includes: a presser 15 configured to press cells of a fuel cell FC, the cells being laminated together and being housed in a fuel cell case C that has a first end that is closed and a second end that is not being closed by a lid; a feeder 61 configured to feed gas to the fuel cell case C while the presser 15 presses the cells of a fuel cell FC at a pressure equal to or higher than a predetermined pressure; and a detector 61 configured to detect leakage of the gas from the fuel cell case C to which the gas is being fed by the feeder 61.

This application is based on and claims the benefit of priority from Japanese Patent Application No. 2024-017396, filed on 7 Feb. 2024, the content of which is incorporated herein by reference.

### BACKGROUND OF THE INVENTION

### Field of the Invention

The present invention relates to a leakage detector.

### Related Art

A leakage detector that has been known in the art tests gas leakage after a plurality of cells of a fuel cell, the cells being laminated together, are housed in a fuel cell case in a process of producing a fuel cell stack (see Patent Document 1).
Patent Document 1: Japanese Unexamined Patent Application, Publication No. 2022-077045

### SUMMARY OF THE INVENTION

The leakage detector senses leakage from the fuel cell stack fastened at an optional load by a fastener configured to fasten a lid to an opening of the fuel cell case of the fuel cell stack in which the laminated cells of a fuel cell have been housed. If leakage is detected by such leakage sensing, the fuel cell stack that has its lid fastened to the fuel cell case has to be disassembled, and then an operation of replacing the cells of the fuel cell has to be performed. This increases man hours in the process of producing a fuel cell stack.

An object of the present invention is to provide a leakage detector that can improve energy efficiency by making it possible to suppress an increase in the number of man hours required in a process of producing a fuel cell stack.

To achieve the object, the present invention provides a leakage detector (e.g., a “case holder 1, a pressure tester 61” to be described later) for detecting leakage from a fuel cell case (e.g., a “fuel cell case C” to be described later) that houses a plurality of cells of a fuel cell (e.g., “cells of a fuel cell FC” to be described later), the cells being laminated together. The leakage detector includes: a presser (e.g., a “presser 15” to be described later) configured to press the cells of a fuel cell, the cells being laminated together and being housed in the fuel cell case that has a first end that is closed and a second end that is not being closed by a lid; a feeder (e.g., a “pressure tester 61” to be described later) configured to feed gas to the fuel cell case while the presser presses the cells of a fuel cell at a pressure equal to or higher than a predetermined pressure; and a detector (e.g., the “pressure tester 61” to be described later) configured to detect leakage of the gas from the fuel cell case to which the gas is being fed by the feeder.

In one preferred embodiment of the present invention, the leakage detector further includes: a first end jig (e.g., a “lower jig 20” to be described later) connected to the first end of the fuel cell case to feed the gas through the fuel cell case into the fuel cell case. In one preferred embodiment, the gas is fed through a channel for the gas to be fed during use of the fuel cell. In one preferred embodiment, the leakage detector further includes: a second end jig (e.g., an “upper jig 30” to be described later) having a sealing structure that blocks the second end of the fuel cell case and that prevents the gas fed from leaking from the fuel cell case.

According to the present invention, a leakage detector that can improve energy efficiency by making it possible to suppress an increase in the number of man hours required in a process of producing a fuel cell stack can be provided.

### BRIEF DESCRIPTION OF THE DRAWINGS

FIG. 1 illustrates a leakage detector according to an embodiment;

FIG. 2 is a top perspective view illustrating a lower jig of the leakage detector according to the embodiment;

FIG. 3 is a bottom perspective view illustrating the lower jig of the leakage detector according to the embodiment;

FIG. 4 is a top perspective view illustrating an upper jig of the leakage detector according to the embodiment;

FIG. 5 is a side view illustrating a bolt to be attached to the upper jig of the leakage detector according to the embodiment;

FIG. 6 illustrates a process of detecting leakage using the leakage detector according to the embodiment; and

FIG. 7 is a flowchart illustrating the process of detecting leakage using the leakage detector according to the embodiment.

### DETAILED DESCRIPTION OF THE INVENTION

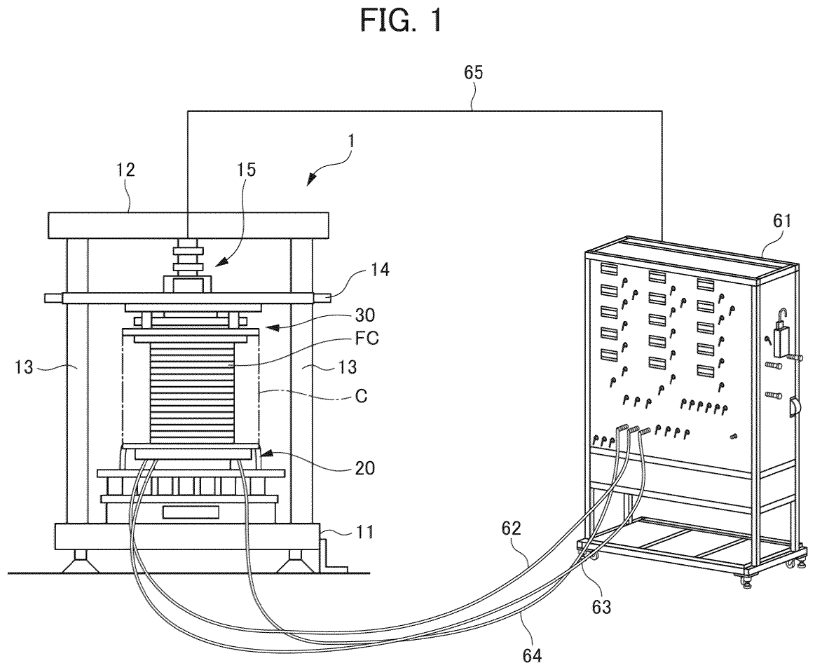

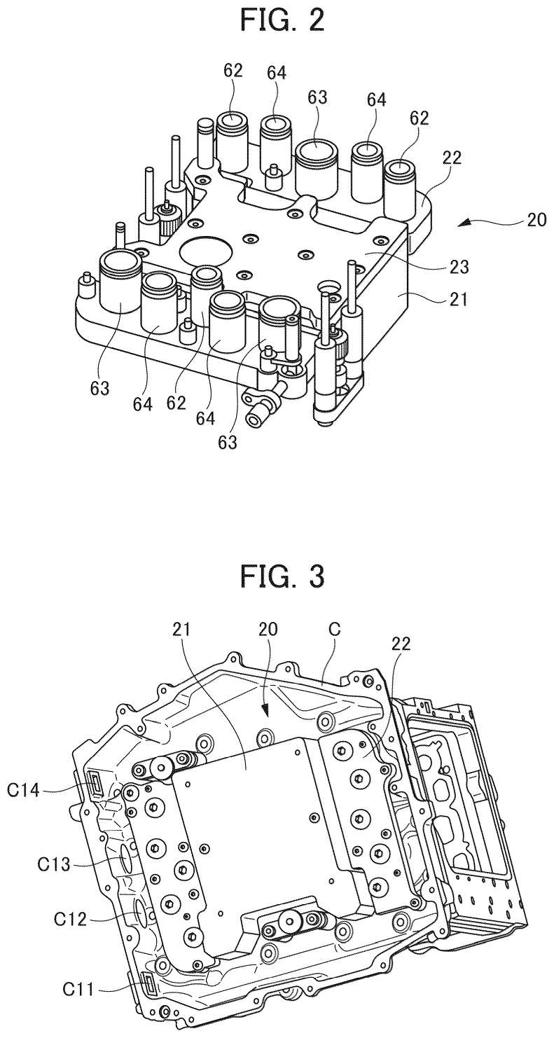

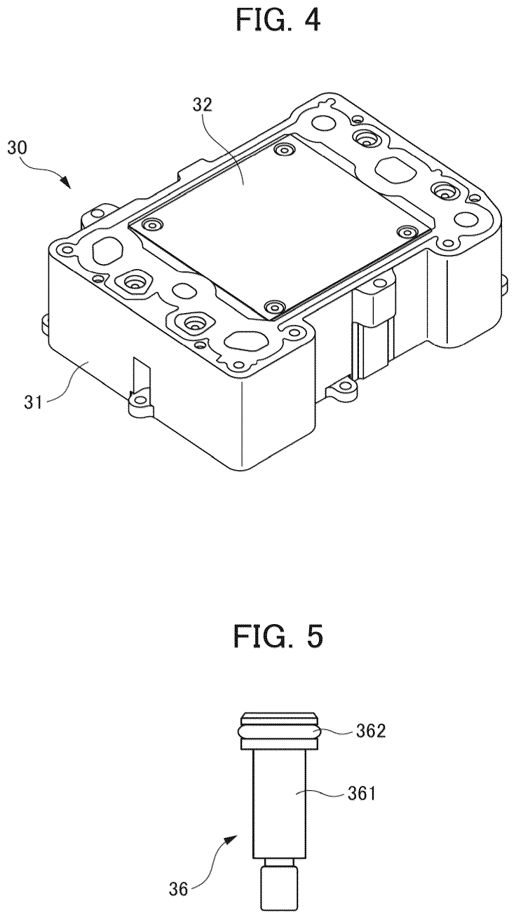

Embodiments of the present invention will be described below. As illustrated in FIG. 1, a leakage detector detects leakage of gas from a fuel cell case C after cells of a fuel cell FC are housed in the fuel cell case C forming part of a fuel cell stack and before a lid F is fastened to the fuel cell case C, and includes a case holder 1 and a pressure tester 61.

The case holder 1 includes a bottom 11, a top board 12, pillars 13, an upper supporting portion 14, a presser 15, a lower jig 20 serving as a first end jig, and an upper jig 30 serving as a second end jig. Pipe members 62, 63, 64 each have a first end connected to the pressure tester 61.

The bottom 11 is the lowermost portion of the case holder 1, and supports the top board 12, the pillars 13, and other components forming part of the case holder 1. The top board 12 is located vertically above the bottom 11, and is supported by the plurality of pillars 13 extending upward from the bottom 11. The upper supporting portion 14 is supported on the plurality of pillars 13 to be upwardly and downwardly movable with respect to the pillars 13 along the pillars 13.

The upper supporting portion 14 is provided with the presser 15. The presser 15 is electrically connected to the pressure tester 61 through an electric circuit 65, such as a conductor or radio waves, and thus the pressure tester 61 can detect the pressure at which the presser 15 applies pressure to the plurality of cells of a fuel cell FC, the cells being laminated together as will be described later.

The upper jig 30 is fixed to the lower end of the presser 15. A portion of the bottom 11 located vertically below the upper jig 30 is provided with the lower jig 20. The bottom of the fuel cell case C is mounted on the upper surface of the lower jig 20. The upper jig 30 hermetically blocks an opening in the upper end of the fuel cell case C mounted on the upper surface of the lower jig 20. Specifically, as illustrated in FIG. 5, the upper jig 30 is connected to the upper end of the fuel cell case C through a bolt 36 around which an O ring 362 is fitted to hermetically block the opening in the upper end of the fuel cell case C. Thus, a sealing structure is formed.

As illustrated in FIG. 3, the lower jig 20 includes a central base 21 in the shape of a rectangular plate, a pair of pipes supporting portions 22 each connected to one of a pair of the shorter sides of the rectangular central base 21, and a mounting portion 23 which is located on almost the entire upper surface of the central base 21 and on which the bottom of the fuel cell case C is mounted.

The pipe members 62, 63, 64 respectively connected to channels for hydrogen gas, air, and cooling water serving as a refrigerant to be fed to a fuel cell stack FCS during the use (operation) of the fuel cell stack FCS (hereinafter referred to as the “channels for the fuel cell stack FCS) each have a second end fixed to an associated one of the pair of the pipe supporting portions 22 of the lower jig 20. The pipe members 62 are illustrated in FIG. 1 in the form of one pipe member for convenience of illustration, but are a pair of the pipe members 62 through one of which the associated fluid is fed to the fuel cell stack FCS and through the other of which the associated fluid is discharged from the fuel cell stack FCS. The pipe members 63 are illustrated in FIG. 1 in the form of one pipe member for convenience of illustration, but are a pair of the pipe members 63 through one of which the associated fluid is fed to the fuel cell stack FCS and through the other of which the associated fluid is discharged from the fuel cell stack FCS. The pipe members 64 are illustrated in FIG. 1 in the form of one pipe member for convenience of illustration, but are a pair of the pipe members 64 through one of which the associated fluid is fed to the fuel cell stack FCS and through the other of which the associated fluid is discharged from the fuel cell stack FCS. Each of the pipe members 62, 63, and 64 through which the associated fluid is fed to the fuel cell stack FCS has an end portion fixed to one of the pair of the pipe supporting portions 22, and each of the pipe members 62, 63, and 64 through which the associated fluid is discharged from the fuel cell stack FCS has an end portion fixed to the other of the pair of the pipe supporting portions 22.

Helium gas for detecting gas leakage can be fed from the pressure tester 61 to the pipe members 62, 63, 64. The channels for the fuel cell stack FCS are configured to allow helium gas to flow therethrough instead of the above-described gases and the refrigerant.

The pressure tester 61 includes therein a controller. The controller inside the pressure tester 61 performs control, via the circuit 65, to enter the value of the pressure at which the presser 15 applies pressure to the plurality of cells of a fuel cell FC, the cells being laminated together. The controller inside the pressure tester 61 performs control to feed the helium gas through each of the pipe members 62, 63, 64 and the lower jig 20 into the fuel cell case C and circulate the helium gas through the fuel cell case C. The pressure tester 61 constitutes a feeder that feeds helium gas. The pressure tester 61 also constitutes a leakage detector that feeds helium gas and simultaneously detects the pressure of the fed helium gas from the fuel cell case C to enable detection of leakage of helium gas from the fuel cell case C.

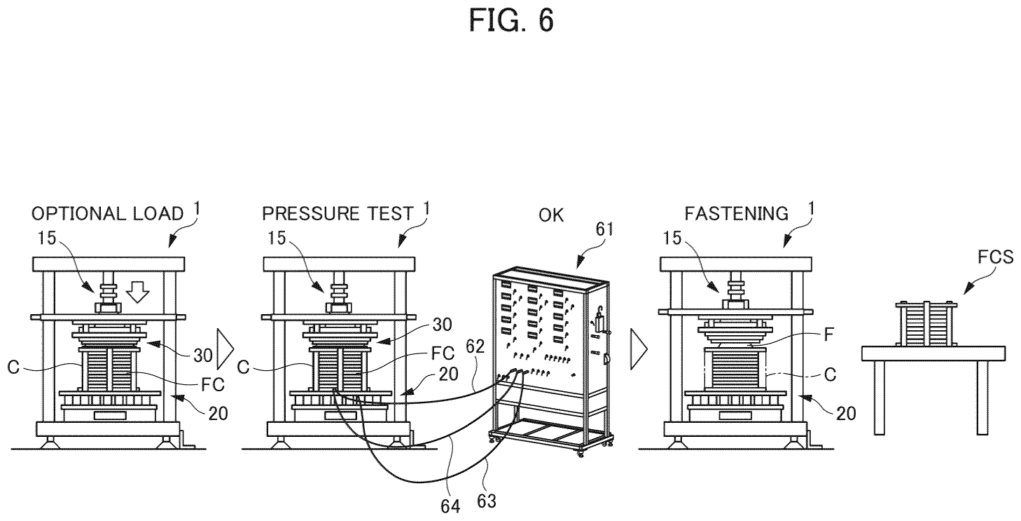

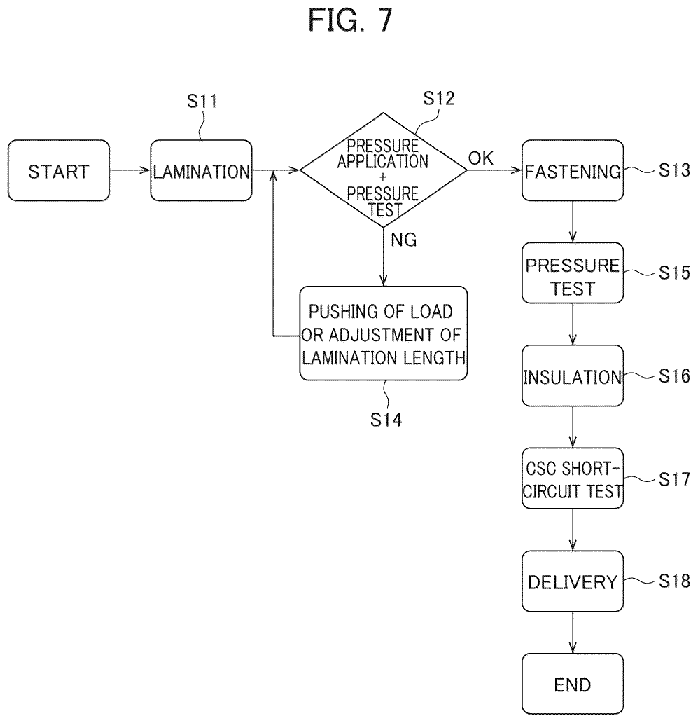

Next, a process of detecting leakage using the leakage detector will be described with reference to FIGS. 6 and 7. In Step S11 of the process of detecting the leakage in FIG. 7, a fuel cell case C is initially mounted on the upper surface of a lower jig 20. The fuel cell case C houses therein a plurality of cells of a fuel cell FC, the cells being laminated, and has its upper end open. Next, each of the pipe members 62, 63, 64 has a second end fixed to the lower jig 20 and connected to the associated channel for the fuel cell stack FCS.

Next, the upper supporting portion 14 is slid with respect to the pillars 13 to move the upper jig 30 downward. Thus, the upper jig 30 blocks the opening in the upper end of the fuel cell case C, and the gap between the fuel cell case C and the upper jig 30 is sealed to prevent the helium gas fed from the pressure tester 61 from leaking, thereby achieving a hermetically sealed fuel cell case C.

Next, in Step S12 shown in FIG. 7, as illustrated in the section “optional load” of FIG. 6, the presser 15 adds an optional load to the laminated fuel cells FC to apply pressure to (or to press) the laminated fuel cells FC, and as illustrated in the section “pressure test” of FIG. 6, while the presser 15 presses the cells of a fuel cell FC, the cells being laminated, at a pressure equal to or higher than a predetermined pressure, a pressure test is performed to detect the pressure of the helium gas with helium gas being fed from the pressure tester 61 to the fuel cell case C. The predetermined pressure is, for example, a pressure equivalent to the pressure applied to the cells of a fuel cell FC, the cells being laminated, in the produced fuel cell stack FCS.

If the result of the pressure test is normal, and leakage is not detected (Step S12: OK), the upper jig 30 is removed from the fuel cell case C, and the opening in the upper end of the fuel cell case C is blocked by a lid F so that the gap between the fuel cell case C and the lid F is hermetically sealed, in Step S13 shown in FIG. 7, as illustrated in the section “fastening” of FIG. 6. Then, the process proceeds to Step S15.

If, as a result of the pressure test, leakage is detected (Step S12: NG), the laminated fuel cells FC are pushed (pressed) at higher load, or the length of a lamination of the cells of a fuel cell FC, the cells being laminated, is adjusted, in Step S14 shown in FIG. 7. Then, the process returns to Step S12.

In Step S15 shown in FIG. 7, helium gas is again fed from the pressure tester 61 to the fuel cell case C with the opening in the upper end of the fuel cell case C blocked by the lid F, and a pressure test is thus performed. A check is made that the result of this pressure test is normal. In Step S16 shown in FIG. 7, a test for insulation between an insulated case and a metal part of the fuel cell stack FCS is performed. Then, in Step S17 shown in FIG. 7, a test is made whether or not attachment of a harness is normal (a C2C short-circuit test). In Step S18 shown in FIG. 7, the fuel cell stack FCS is delivered. Then, the process of producing the fuel cell stack FCS ends.

The foregoing embodiment provides the following advantages. In this embodiment, the leakage detector includes the presser 15 configured to press the cells of a fuel cell FC, the cells being laminated and being housed in the fuel cell case C having a closed lower end that corresponds to the first end and an upper end that corresponds to the second end and that is not being closed by the lid F, the pressure tester 61 corresponding to the feeder configured to feed gas to the fuel cell case C while the presser 15 presses the cells of a fuel cell FC at a pressure equal to or higher than the predetermined pressure, and the pressure tester 61 corresponding to the leakage detector configured to detect the leakage of helium gas from the fuel cell case C to which the helium gas is being fed by the pressure tester 61.

Thus, a pass or fail determination regarding the pressure test can be made before the lid F is fastened to the fuel cell case C. This can extremely reduce rearrangement operations to be performed if the pressure test after the fastening of the lid F to the fuel cell case C is failed.

In this embodiment, the leakage detector includes the lower jig 20 that corresponds to the first end jig and that is connected to the lower end of the fuel cell case C in the form of a first end portion of the fuel cell case C to feed helium gas through the fuel cell case C. Thus, feeding helium gas to the lower jig 20 enables circulation of helium gas through the fuel cell case C into the fuel cell case C. This eliminates the need for separately providing a component for feeding and circulating helium gas into and through the fuel cell case C, thus facilitating the pressure test.

In this embodiment, helium gas is fed into the fuel cell case C through the channels for hydrogen gas, air, and a refrigerant to be fed during the use of the fuel cell stack FCS. This allows the pressure test to be performed in channels for actual use during the use of the fuel cell stack FCS. In addition, the pressure test is performed using gaseous helium atoms that have a small diameter and that do not explode, for example. This enables accurate and safe detection of leakage.

In this embodiment, the leakage detector includes the upper jig 30 that corresponds to the second end jig and that has a sealing structure blocking the opening in the upper end of the fuel cell case C in the form of a second end portion of the fuel cell case C and preventing the fed helium gas from leaking from the fuel cell case C. This allows the pressure test to be performed with the upper end of the fuel cell case C blocked by the sealing structure, just like the fuel cell stack FCS. This enables an accurate pressure test.

The present invention is not limited to the foregoing embodiment, and as long as it is possible to achieve the object of the present invention, variations, modifications and the like are included in the present invention. For example, the configurations of various devices of the present invention, such as the presser, the feeder, and the leakage detector, should not be limited to those of the presser 15, the pressure tester 61, and other devices of this embodiment.

### EXPLANATION OF REFERENCE NUMERALS

1 Case Holder (Leakage Detector)
15 Presser
20 Lower Jig (First End Jig)
30 Upper Jig (Second End Jig)
61 Pressure Tester (Leakage Detector, Feeder, Detector)
C Fuel Cell Case
FC Cell of Fuel Cell

What is claimed is:

1. A leakage detector for detecting leakage from a fuel cell case that houses a plurality of cells of a fuel cell, the cells being laminated together, the leakage detector comprising:
a presser configured to press the cells of a fuel cell, the cells being laminated together and being housed in the fuel cell case that has a first end that is closed and a second end that is not being closed by a lid;
a feeder configured to feed gas to the fuel cell case while the presser presses the cells of a fuel cell at a pressure equal to or higher than a predetermined pressure; and
a detector configured to detect leakage of the gas from the fuel cell case to which the gas is being fed by the feeder.

2. The leakage detector according to claim 1 further comprising:
a first end jig connected to the first end of the fuel cell case to feed the gas through the fuel cell case into the fuel cell case.

3. The leakage detector according to claim 2, wherein
the gas is fed through a channel for the gas to be fed during use of the fuel cell.

4. The leakage detector according to claim 1 further comprising:
a second end jig having a sealing structure that blocks the second end of the fuel cell case and that prevents the gas fed from leaking from the fuel cell case.
